(19) United States
(12) Patent Application Publication
(10) Pub. No.: US 2023/0064851 A1
(43) Pub. Date: Mar. 2, 2023

(54) SYSTEMS AND METHODS FOR PROVIDING CONTACT ENGAGEMENT VISUALIZATION ACROSS COMMUNICATION CHANNELS

(71) Applicant: salesforce.com, inc., San Francisco, CA (US)

(72) Inventors: Gang SHU, South San Francisco, CA (US); Natasha Wu, Saratoga, CA (US); Jong Lee, Pleasanton, CA (US)

(73) Assignee: salesforce.com, inc., San Francisco, CA (US)

(21) Appl. No.: 17/410,028

(22) Filed: Aug. 24, 2021

(51) Int. Cl. G06Q 10/10; H04L 12/24; G06Q 30/02

(52) U.S. Cl. CPC G06Q 10/1093; H04L 41/5064; G06Q 30/0201; G06Q 30/016

(57) ABSTRACT

A method for aggregating and generating contact engagement data for contacts in a customer relationship management (CRM) system includes receiving a plurality of communications via a plurality of communication channels, extracting message objects from each communication, the message objects including a sender address, a recipient address, a message body, and a corresponding communication channel for each communication. A contact based on at least one of the message objects for each communication is identified. A subset of the message objects corresponding to communications associated with the contact among the plurality of communications is aggregated to obtain aggregated message data. A visual representation of the aggregated message data is generated for display, the visual representation comprising a temporal distribution of the subset of the message objects corresponding to the communications associated with the contact and the corresponding communication channels for each of the communications associated with the contact.

### BACKGROUND

Contact management is an important feature for customer relationship management (CRM) systems. CRM systems allow users to maintain and develop customer relationships and manage interactions with their contacts. Current CRM systems offer user interfaces showing a chronological view of messages in order of occurrence over a period of time. However, such user interfaces may be cumbersome for users of a CRM system to identify how frequently they communicate with certain contacts in order to assess contact engagement.

In some cases, the chronological view might show a timeline of most recent messages with a specific contact through one communication channel, such as email, but might not provide sufficient information for users to visualize all interactions with the specific contact on a variety of communication channels and over various periods of time. As a result, users may inadvertently over-communicate or under-communicate with certain contacts without properly distributing their engagement with contacts.

Accordingly, there may be a need for systems and methods to generate and provide contact engagement information to users in an improved and efficient manner.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIG. 1 illustrates a block diagram of a contact engagement aggregation platform in a communication architecture, according to some embodiments.

FIGS. 2A and 2B are example user interfaces illustrating a contact engagement visualization, according to some embodiments.

FIG. 3 illustrates a method for aggregating and generating contact engagement data for contacts in a CRM system, according to some embodiments.

FIG. 4 illustrates a method for presenting a visual representation of aggregated message data on a user interface, according to some embodiments.

FIG. 5 illustrates an example computer system useful for implementing various embodiments.

The present disclosure will be described with reference to the accompanying drawings. In the drawings, like reference numbers indicate identical or functionally similar elements. Additionally, the left-most digit of a reference number identifies the drawing in which the reference number first appears.

### DETAILED DESCRIPTION

Provided herein are system, apparatus, device, method and/or computer program product embodiments, and/or combinations and sub-combinations thereof, for generating contact engagement visualizations based on retrieving and aggregating data from across a plurality of communication channels for a CRM system.

Traditionally, CRM systems (and/or contact management systems) allow users to manage their contacts and read conversational messages with contacts in a chronological timeline format. Users may retrieve a message with a particular contact by a text search or by scrolling through a list of messages associated with the contact in the user interface. However, chronological timeline user interfaces may be limited for facilitating contact engagement assessment for various reasons.

In some cases, the user interface may merely display a limited view of messages with a contact and lack the functionality to provide a comprehensive view or any additional details on the overall communications with the contact. Furthermore, while the user interface may provide message-filtering capabilities for users to narrow messages down to a selected date or date range, users may be unaware of the different communication channels used to interact with a contact to assess contact engagement. For instance, users might not be able to visualize how many messages have been sent to particular contacts, how frequently users have engaged with said contacts, and which communication channels have been used for contact engagement. Due to the limitations of chronological user interfaces in CRM systems, contact management systems, users may inadvertently under-communicate or over-communicate with contacts, without proper distribution of interactions with a variety of contacts.

The present disclosure addresses the limitations of the current CRM user interfaces and provides improved systems, computing platforms, and methods for efficient visualization and accessibility of contact engagement information by users. A contact engagement aggregation platform may be used to integrate cross-channel communications in the CRM system, extract contact engagement information, and provide aggregated data to users. In some embodiments, aggregated contact engagement data is displayed given a particular contact and/or a particular communication channel. In some embodiments, the aggregated data shows the frequency of engagement with a particular contact on a given day, and provides visual cues (e.g., different colors, shades, patterns, or the like) to convey information on the different communication channels and number of communications.

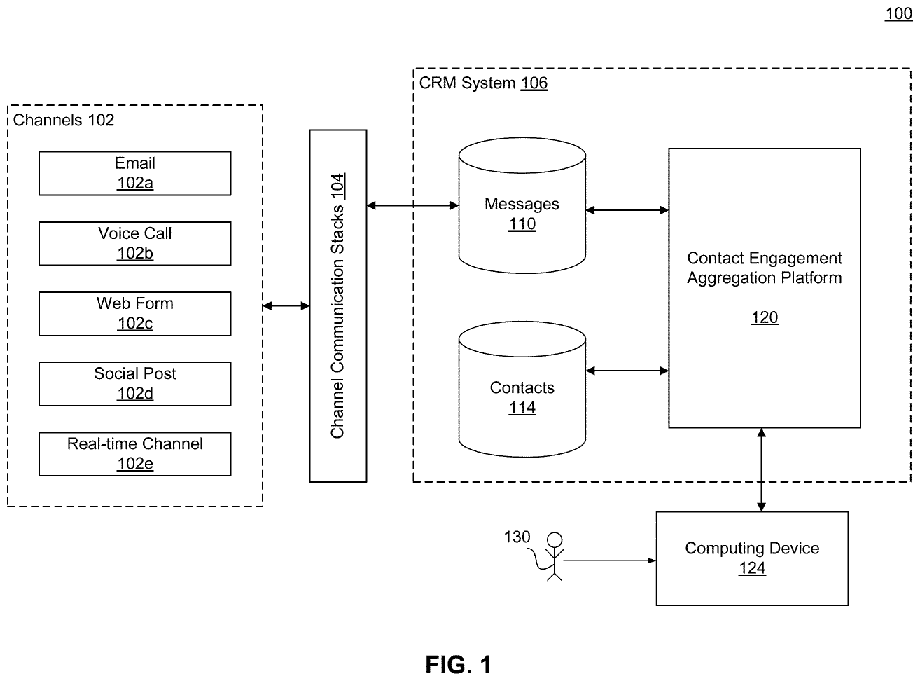

FIG. 1 illustrates a communication architecture 100, in accordance with an embodiment. Communication architecture 100 includes a plurality of communication channels 102, channel communication stacks 104, CRM system 106, computing device 124, and user 130. In some embodiments, communication channels 102 may be referred to herein as channels 102.

Various communication channels 102 are provided by which customers or potential customers may reach out to a business (e.g., via contact with sales or service relationship managers), and vice versa. In some embodiments, a user 130 of the CRM system 106 may communicate with various customers (e.g., contacts) through the different communication channels 102. In some embodiments, the user 130 may be a member of a business, organization, and/or other suitable group. For example, the user 130 may be a sales, service, or support relationship manager. In some embodiments, the user 130 may be associated with and operate the computing device 124. While one user 130 and one computing device 124 is illustrated in FIG. 1 for reference, there may be any number of users 130 and computing devices 124 in communication architecture 100.

In some embodiments, the computing device 124 may be a personal digital assistant, desktop workstation, laptop or notebook computer, netbook, tablet, smart phone, mobile phone, smart watch or other wearable, appliance, augmented reality (AR) device, virtual reality (VR) device, part of the Internet-of-Things, and/or embedded system, to name a few non-limiting examples, or any combination thereof. In some embodiments, the computing device 124 may include one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by the CRM system 106 and the contact engagement aggregation platform 130.

In some embodiments, the user 130 may utilize the computing device 124 to interact with the CRM system 106 and engage with customers through communication channels 102. In some embodiments, communication channels 102 may include, by way of non-limiting example, emails 102a, voice calls 102b, web forms 102c, social postings 102d, and real-time channels 102e. In some embodiments, web forms 102c may include any fillable form that a customer can fill out on a website. In some embodiments, social postings 102d may include communications via social media platforms such as Facebook, Twitter, YouTube, Instagram, LinkedIn, Google+, Sina Weibo, or the like. In some embodiments, real-time channels 102e may include instant messaging or direct messaging, live agent chats, SMS, Facebook messages, WhatsApp, WeChat, Apple Business Chat, or the like.

Channel communication stacks 104 provide software code configured to interface with each of communication channels 102 as needed (e.g., via an application programming interface (API) for the channel). Channel communication stacks 104 are configured to read a variety of data fields for each type of communication (often unique to each channel 102) and provide them to the CRM system 106. Channel communication stacks 104 are connected during operation to each communication channel 102 source, such as an email server, social media API, or SMS service, by way of non-limiting example.

In some embodiments, the CRM system 106 may capture information fields from incoming communications by a possible contact 114 or outgoing communications to the possible contact 114 over the different communication channels 102 using the channel communication stacks 104. For example, if the communication is an email (e.g., channel type being email 102a), the CRM system 106 may capture email addresses, including a sender address and a recipient address, a message body of the email, a first name and/or last name of the contact, and a company name and title of the contact (e.g., from a user signature of the email). In some embodiments, the CRM system 106 may capture a user name and/or user avatar from communications transmitted over social postings 102d (e.g., social media postings) or from real-time channels 102e (e.g., Facebook Messenger, WeChat, Whatsapp, or the like). In some embodiments, the CRM system 106 may also capture a phone number from a voice call 102b or text message (SMS) (e.g., real-time channel 102e). One skilled in the relevant arts will recognize that these exemplary information fields for channels 102 are not limiting, and that additional information can be captured from a variety of channels 102 (e.g., header information) or derived (e.g., information in a signature block) from the communication itself.

In some embodiments, the communications and data obtained for the different data fields for each type of communication may be managed by a message handler (not shown) in the CRM system 106. In some embodiments, the CRM system 106 may collect a plurality of communications transmitted over channels 102 and index the communications to sort the communications by the different data fields. In some embodiments, the CRM system 106 may store the indexed communications in messages 110, in which a message and data obtained from the data fields for each communication may be stored.

In some embodiments, the contact engagement aggregation platform 120 may be integrated within the CRM system 106. The contact engagement aggregation platform 120 may represent a module, apparatus, dedicated device, general-purpose processor, engine, state machine, application, functional element, or related technology capable of and configured to perform corresponding operations described herein. In some embodiments, the contact engagement aggregation platform 120 may implement the extraction and aggregation data functionalities as described herein.

In some embodiments, the contact engagement aggregation platform 120 may be configured to extract message objects from each communication stored in messages 110. In some embodiments, a message object may include a data construct or record that provides a description of a message in the CRM system 106, such as a category of customer data, specifically contact information or account information, or the like. In some embodiments, the message object may include the message body (or call log data, if the communication is a call), identifiers for the sender and/or recipient, and a channel identifier. In some embodiments, the contact engagement aggregation platform 120 may extract message objects, including a sender address, a recipient address, a message body, and a corresponding communication channel 102 of the plurality of communication channels for each communication. For example, the CRM system 106 may initially capture data from different information fields from communications and store the captured data and communications in the messages 110. The contact engagement aggregation platform 120 may further extract relevant information (e.g., message objects comprising a sender address, a recipient address, a message body, and a corresponding communication channel 102) from the captured data and communications in the messages 110.

In some embodiments, the contact engagement aggregation platform 120 may use the extracted message objects from messages 110 to identify contact information. In some embodiments, the contact engagement aggregation platform 120 may identify one or more contacts based on parsing message objects corresponding to each communication, such as by analyzing a sender address, a recipient address, a message body, and a communication channel 102 of each communication to identify contact names and contact information. In some embodiments, the contact engagement aggregation platform 120 may store the contact information in contacts 114 in CRM system 106. In some embodiments, the CRM system 106 may create a new contact 114 for each identified contact and add the contacts 114 as CRM customer records.

In some embodiments, the CRM system 106 may identify a contact to be a new contact 114 and create a new customer record corresponding to the new contact in the CRM system 106, in which the new customer record stores message objects corresponding to communications associated with the contact and corresponding communication channels 102 for each of the communications associated with the contact. In some embodiments, the CRM system 106 may identify an existing contact in contacts 114 (e.g., in CRM customer records in the CRM system 106) based on parsing the extracted message objects from an incoming communication over one of the channels 102 and associate the data from the incoming communication (e.g., the extracted message objects) with the existing contact in contacts 114.

In some embodiments, the contact engagement aggregation platform 120 may use the identified contacts 114 and extracted message objects to aggregate data for visualization by the user 130. In some embodiments, the contact engagement aggregation platform 120 may aggregate a subset of the message objects corresponding to communications associated with an identified contact among the plurality of communications to obtain aggregated message data. For example, the user 130 may use the computing device 124 to select a contact on a user interface for the CRM system 106 as displayed. The contact engagement aggregation platform 120 may receive the user selection from the computing device 124 and aggregate the message objects of communications sent to and/or from the selected contact to obtain aggregated message data. In some embodiments, the contact engagement aggregation platform 120 may identify a frequency of communications with a selected contact over one or more predetermined periods of time based on the aggregated message data. In some cases, the contact engagement aggregation platform 120 may identify a frequency of communications based on computing a number of message objects corresponding to communications with an identified contact for each predetermined period of time.

In some embodiments, the aggregated message data may include compiled data for each communication associated with the selected contact and may be presented as a list or a histogram in a calendar view on the user interface for the CRM system 106 as displayed on the computing device 124. The aggregated message data may show previews or snippets of each communication including at least one of a sender address, a recipient address, a message body, and a corresponding communication channel. In some embodiments, the aggregated message data may be presented for a weekly, monthly, annual, five year, or another period of time view for identifying the frequency of communications with a contact through different channels 102.

In some embodiments, the contact engagement aggregation platform 120 may generate a visual representation of the aggregated message data for display, in which the visual representation includes a temporal distribution of the subset of the message objects corresponding to the communications associated with the contact and the corresponding communication channels for each of the communications associated with the contact. As a result, users 130 (e.g., sales and support relationship managers) can experience a more efficient inbox view and user interface for the CRM system 106 that shows a comprehensive calendar view of the frequency of communications with various contacts across all the different channels 102 available.

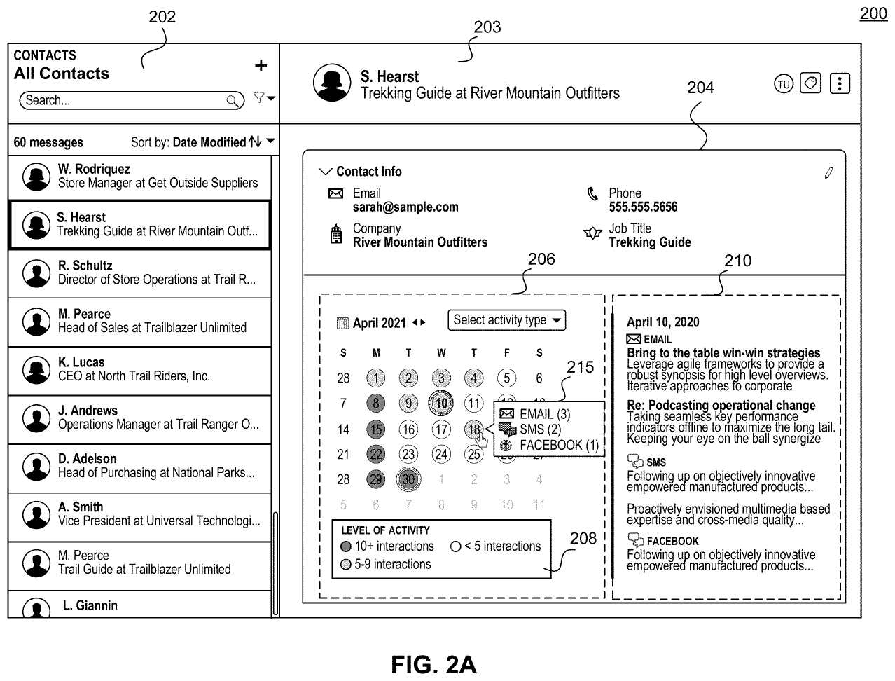

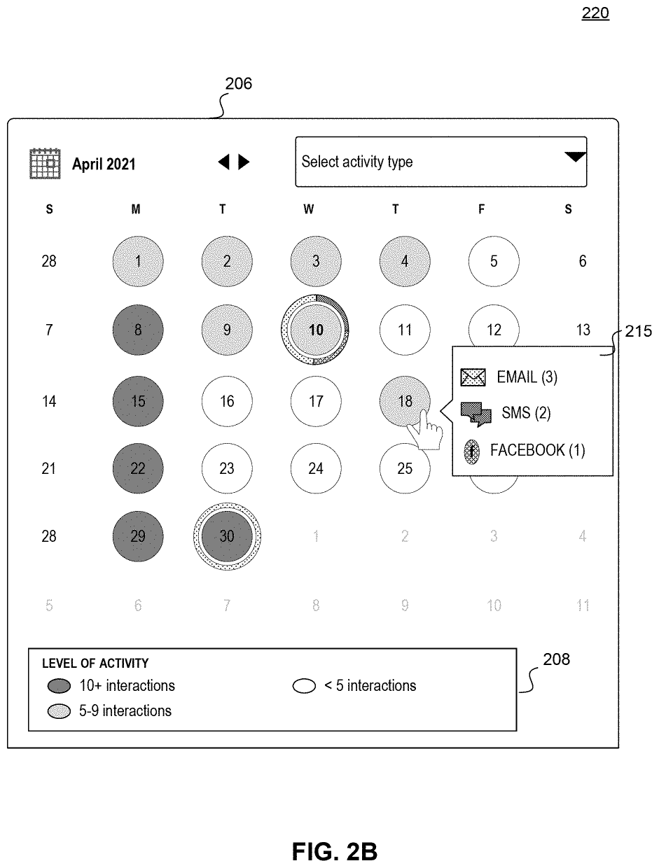

FIGS. 2A and 2B are example user interfaces illustrating a contact engagement visualization for the CRM system 106, according to some embodiments. In some embodiments, FIGS. 2A and 2B illustrate user interfaces 200 and 220, respectively, which may be generated by the CRM system 106 and presented on computing device 124 to the user 130. The user interface 200 of FIG. 2A shows a contacts list 202, a contact 203, a contact preview 204, a calendar view 206, and an aggregated message preview 210, whereas the user interface 220 of FIG. 2B shows the calendar view 206. In some embodiments, the user interfaces 200 and 220 may represent the same exemplary embodiment, with the user interface 220 in FIG. 2B illustrating a closer view of the calendar view 206.

In some embodiments, the contacts list 202 includes the contacts (e.g., customers) of the CRM system 106 and is shown, by way of example, on the left side of the user interface 200. In some embodiments, the contacts shown in contacts list 202 may correspond to the contacts 114 in the CRM system 106 of FIG. 1. In some embodiments, the user 130 may be able to navigate through the different contacts in the contacts list 102 by scrolling, searching or filtering by different contact information or keywords.

In some embodiments, the CRM system 106 may generate the data corresponding to at least one of the contact 203, contact preview 204, calendar view 206, and aggregated message preview 210 based on user selection of a contact in the contacts list 202. In some embodiments, the CRM system 106 may receive the user selection of the contact from the computing device 124, generate the data based on the user selection of the contact, and transmit the generated data to the computing device 124 for display on the user interface 200.

Upon selection of a contact in the contacts list 202, the user interface 200 shows the contact 203, contact preview 204, calendar view 206, and aggregated message preview 210 in the user interface 200. For example, upon selection of the contact name “S. Hearst,” the user interface 200 displays the contact's full name, job title, and company name in the contact 203 window, as well as additional contact information in the contact preview 204 window. In some embodiments, the contact preview 204 window may include an email address, a phone number, job title, and company name of the selected contact.

The calendar view 206 in the user interface 200 shows a monthly view of communications with the selected contact over a plurality of days. In some embodiments, the calendar view 206 may show a view of communication over a week, quarter, year, or another period of time. In some embodiments, each day in the monthly view corresponds to a visual cue or visual indicator (e.g., a color shade) representing a predefined level of activity as defined by the legend 208 shown at the bottom of the calendar view 208. In some embodiments, the legend 208 may define different levels of activity or interactions (e.g., communications) with the selected contact, in which each level corresponds to a different color, shade, or tint (e.g., different intensity levels). For example, a first predefined level may represent a first predefined range or number of communications and may correspond to a first color, a second predefined level may represent a second predefined range or number of communications and may correspond to a second color, a predefined third level may represent a third predefined range or number of communications and may correspond to a third color, and so forth. For example, the first, second, and third levels and/or colors may be different from each other as shown in FIGS. 2A and 2B. While the legend 208 in FIGS. 2A and 2B illustrate three predefined levels defining different predefined ranges or numbers of communication for reference, there may be any number of predefined levels with predefined ranges/numbers and corresponding colors in legend 208. In some embodiments, the user 130 may be able to visually assess how frequently they have interacted with a selected customer by observing the different colors or shades corresponding to each day in the monthly view as shown in the calendar view 206.

In some embodiments, the calendar view 206 also provides information on which communication channels 102 were used to communicate with the selected contact on each day. In some embodiments, each day in the monthly view may include a visual indicator or visual representation (e.g., a ring or any other shape around the day) showing the different communication channels 102 on the corresponding days. For example, the ring around the day for April 10 in the calendar view 206 may include three portions, each with a different shade or pattern representing a different communication channel 102. In another example, the ring around the day for April 30 in the calendar view 206 may include a single portion representing one communication channel 102. In other words, the user 130 may have email, SMS, and Facebook communications with the selected contact on April 10, and the user 130 may have email communications with the selected contact on April 30.

The calendar view 206 further includes a channel preview 215. In some embodiments, the user 130 may use their cursor to hover over a day in the calendar view 206 and view the channel preview 215. The channel preview 215 may display a number of communications on each channel 202 with the selected contact on a specific day. For example, the channel preview 215 may indicate that the user 130 has three email communications, two SMS communications, and one Facebook communication with the selected contact on April 18. In some embodiments, the channel preview 215 may provide the user 130 with a high-level summary of communications with a breakdown of different engagement types with a specific contact. In some embodiments, the channel preview 215 may also include a preview of media (e.g., one or more photos, videos, music, and the like) attached in email communications or corresponding to the SMS, social media communications, or other channel communications.

In addition to using a cursor to hover over a specific day in the calendar view 206, the user 130 may also use their cursor to click on or select a specific day in the calendar view 206 to generate an aggregated message preview 210 in the user interface 200. In some embodiments, the aggregated message preview 210 may provide a detailed panel that displays snippets of messages and actionable content (e.g., links to email threads), or the like. In some embodiments, the aggregated message preview 210 may include a preview of communications with the selected contact in the different channels 202. In some embodiments, the aggregated message preview 210 may provide a few lines of text corresponding to each communication with the selected contact, such as one or more email snippets, text excerpts, or the like. In some embodiments, the aggregated message preview 210 may organize the communications of the selected day by different channel types. In other embodiments, the aggregated message preview 210 may organize the communications of the selected day in chronological order, such as in the order of the time the communications are received from and/or sent to the selected contact on the selected day.

In some embodiments, the CRM system 106 may provide customization and personalization options to users for display of the aggregated data on user interfaces 200 and 220. In other embodiments, an administrator of the CRM system 106 may set an organization-level theme for the user interfaces 200 and 220. In some embodiments, there may be a default color chosen for elements in the calendar view in the user interfaces 200 and 220. For example, the administrator may select a first color to represent days in a first season (e.g., the color red to mark days in a month during a summer season) and a second color to represent days in a second season (e.g., the color gold or brown to mark days in a month during a fall season). In other embodiments, a user (e.g., user 130) may be able to override an organization-level theme for the user interfaces 200 and 220 and set their own color theme.

In some embodiments, the CRM system 106 may also offer the display of recent images that were attached in a conversation with an identified contact on a given day. For example, the user interfaces 200 and 220 may show recent images associated with different communications in the CRM system 106. The display of recent images may make conversation or communication-searching much easier as attached images can provide visual indicators on contact engagement topics on a given day. In some embodiments, the CRM system 106 may further provide user interface variations to support displaying a visual representation using a default desktop view and/or a mobile view. In some embodiments, the visual representation may be displayed via a default monthly calendar view (e.g., calendar view 206), as well as via weekly, bi-weekly, and/or annual views.

In some embodiments, the user interfaces 200 and 220 may include various functionalities, such as allowing users to quickly skip from month to month to see a high-level visual summary of communications, as well as activity type dropdown filters on channels 102 to see emails, SMS messages, Facebook communications, or the like.

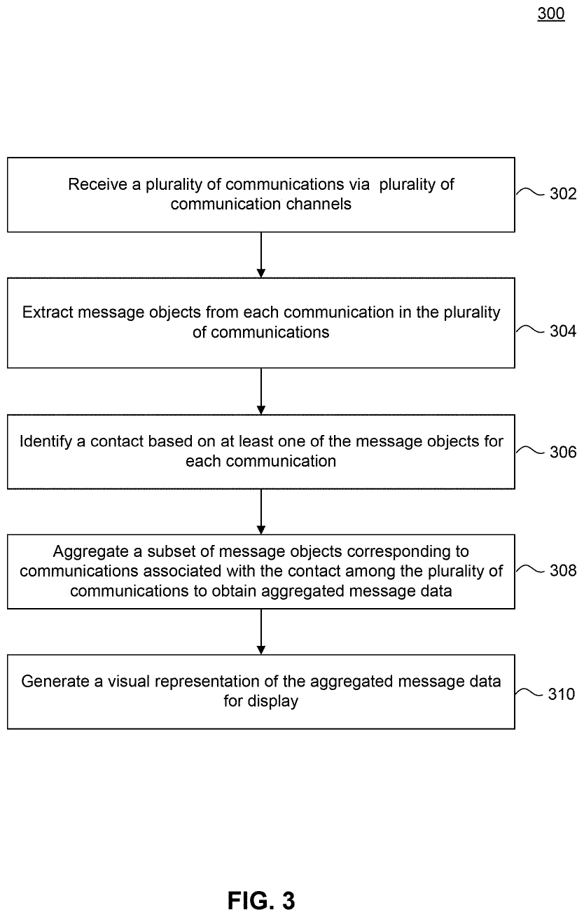

FIG. 3 illustrates a method 300 for aggregating and generating contact engagement data for contacts in a CRM system, according to some embodiments. Method 300 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art(s).

In 302, the CRM system 106 may receive a plurality of communications via a plurality of communication channels 102, as described above with reference to FIG. 1. In some embodiments, In some embodiments, channel communication stacks 104 may be connected to each communication channel 102 to allow the CRM system 106 to receive the communications between customers and users (e.g., sales and support relationship managers) of the CRM system 106.

In 304, the CRM system 106 may extract message objects from each communication in the plurality of communications. In some embodiments, the contact engagement aggregation platform 120 in the CRM system 106 may perform the extraction of message objects from each communication. In some embodiments, the message objects may include a sender address, a recipient address, a message body, and a corresponding communication channel of the plurality of communication channels for each communication.

In 306, the contact engagement aggregation platform 120 in the CRM system 106 may identify a contact based on at least one of the message objects for each communication. In some embodiments, the contact engagement aggregation platform 120 may parse message objects corresponding to each communication, such as by analyzing a sender address, a recipient address, a message body, and a communication channel 102 of each communication to identify contact names and contact information.

In 308, the contact engagement aggregation platform 120 in the CRM system 106 may aggregate a subset of message objects corresponding to communications associated with the contact among the plurality of communications to obtain aggregated message data. In 310, the contact engagement aggregation platform 120 in the CRM system 106 generate a visual representation of the aggregated message data for display. In some embodiments, the visual representation may include a temporal distribution of the subset of the message objects corresponding to the communications associated with the contact and the corresponding communication channels for each of the communications associated with the contact.

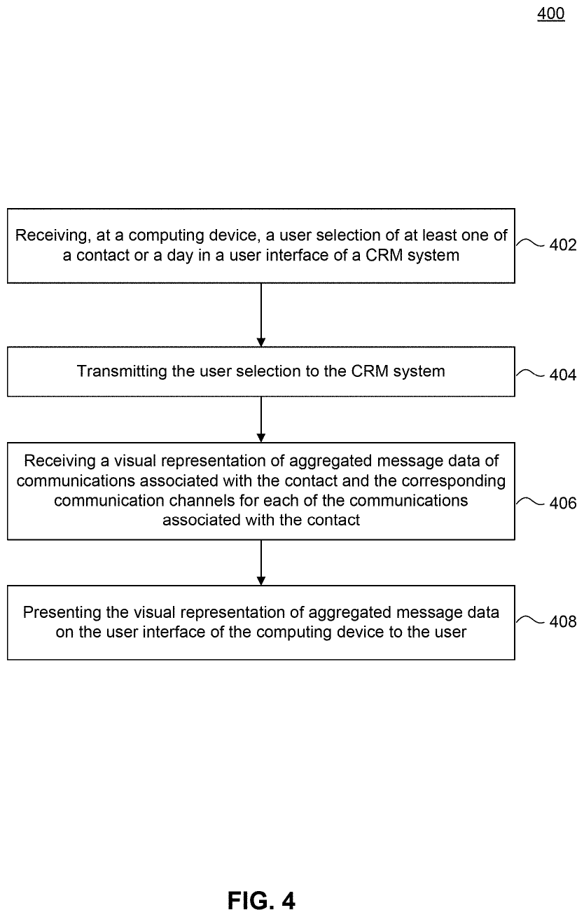

FIG. 4 illustrates a method 400 for presenting a visual representation of aggregated message data on a user interface, according to some embodiments. Method 400 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art(s).

In 402, the computing device 124 may receive a user selection of at least one of a contact or a day in a user interface of a CRM system 106. In some embodiments, the user 130 at the computing device 124 may select a contact in the contact list 202 or a day in a calendar view 206 of the user interface 200. In 404, the computing device 124 may transmit the user selection to the CRM system 106. In some embodiments, the contact engagement aggregation platform 120 in the CRM system 106 may receive the user selection from the computing device 124 and generate a visual representation of aggregated message data in response to the user selection.

In 406, the computing device 124 may receive the visual representation of aggregated message data of communications associated with the selected contact and/or the selected day and the corresponding communication channels for each of the communications associated with the selected contact and/or the selected day. In some embodiments, the computing device 124 may receive data corresponding to the visual representation, including data regarding a temporal distribution of a subset of message objects for each of the communications for the selected contact and/or the selected day. In some embodiments, the temporal distribution may include a frequency of communications with the contact based on the aggregated message data for the selected day or over a predetermined period of time.

In 408, the computing device 124 may present the visual representation of aggregated message data on the user interface of the computing device to the user. In some embodiments, the computing device 124 may present the visual representation of aggregated message data on a user interface, such as user interfaces 200 or 220.

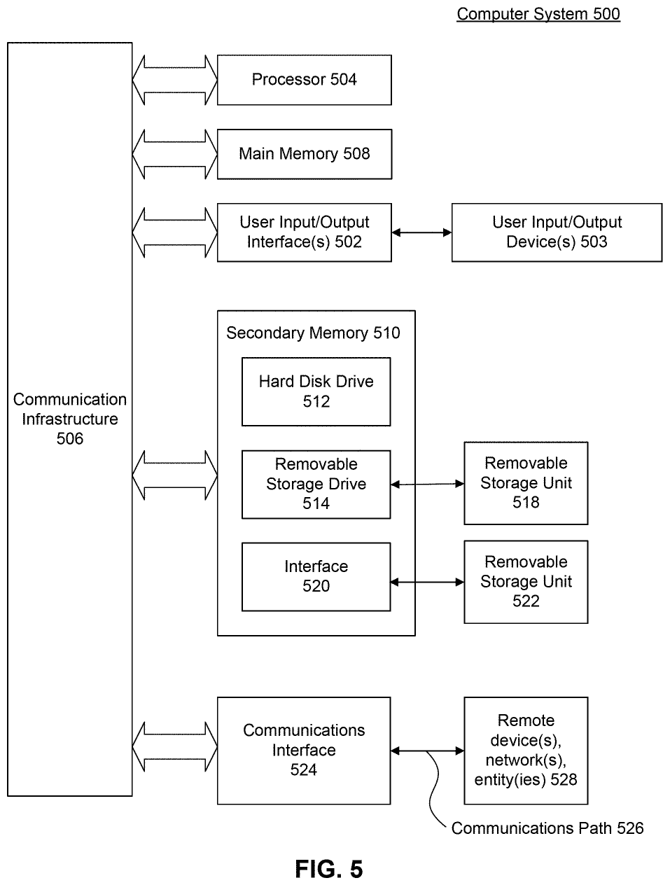

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 508, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method of aggregating and generating contact engagement data for a plurality of contacts in a customer relationship management (CRM) system, comprising:
receiving, by one or more computing devices, a plurality of communications via a plurality of communication channels;
extracting, by the one or more computing devices, message objects from each communication in the plurality of communications, the message objects comprising a sender address, a recipient address, a message body, and a corresponding communication channel of the plurality of communication channels for each communication;
identifying, by the one or more computing devices, a contact based on at least one of the message objects for each communication;
aggregating, by the one or more computing devices, a subset of the message objects corresponding to communications associated with the contact among the plurality of communications to obtain aggregated message data; and
generating a visual representation of the aggregated message data for display, the visual representation comprising a temporal distribution of the subset of the message objects corresponding to the communications associated with the contact and the corresponding communication channels for each of the communications associated with the contact.

2. The method of claim 1, wherein generating the visual representation of the aggregated message data for display comprises generating a calendar view showing the communications associated with the contact and the corresponding communication channels for each of the communications associated with the contact over a predetermined period of time.

3. The method of claim 2, wherein the predetermined period of time comprises a week, a month, a quarter, a year, or a multiple number of years.

4. The method of claim 2, further comprising:
identifying, by the one or more computing devices, a frequency of communications with the contact based on the aggregated message data over the predetermined period of time.

5. The method of claim 4, wherein:
the predetermined period of time comprises a plurality of days, and
the calendar view further shows the frequency of communications with the contact over the plurality of days.

6. The method of claim 5, wherein;
at least one day in the plurality of days shown in the calendar view comprises a first visual indicator with an intensity level corresponding to a number of message objects in the subset corresponding to communications associated with the contact on the at least one day, and
at least one day in the plurality of days shown in the calendar view comprises a second visual indicator representing the corresponding communication channels for each of the communications associated with the contact on the at least one day.

7. The method of claim 6, wherein the first visual indicator comprises a color, the intensity level comprises a predetermined shade of the color, and the second visual indicator comprises a ring shape around the at least one day in the plurality of days shown in the calendar view.

8. The method of claim 1, further comprising:
receiving, from a user device, a user selection of at least one of the contact and a date, wherein the visual representation of the aggregated message data is generated in response to the user selection; and
transmitting the visual representation of the aggregated message data to the user device for display, wherein the user device is associated with a user of the CRM system.

9. A system configured to aggregate and generate contact engagement data for a plurality of contacts for customer relationship management, comprising:
a memory configured to store operations; and
one or more processors configured to perform the operations, the operations comprising:
receiving a plurality of communications via a plurality of communication channels;
extracting message objects from each communication in the plurality of communications, the message objects comprising a sender address, a recipient address, a message body, and a corresponding communication channel of the plurality of communication channels for each communication;
identifying a contact based on at least one of the message objects for each communication;
aggregating a subset of the message objects corresponding to communications associated with the contact among the plurality of communications to obtain aggregated message data; and
generating a visual representation of the aggregated message data for display, the visual representation comprising a temporal distribution of the subset of the message objects corresponding to the communications associated with the contact and the corresponding communication channels for each of the communications associated with the contact.

10. The system of claim 9, wherein generating the visual representation of the aggregated message data for display comprises generating a calendar view showing the communications associated with the contact and the corresponding communication channels for each of the communications associated with the contact over a predetermined period of time.

11. The system of claim 10, the operations further comprising:
identifying, by the one or more computing devices, a frequency of communications with the contact based on the aggregated message data over the predetermined period of time.

12. The system of claim 11, wherein:
the predetermined period of time comprises a plurality of days, and
the calendar view further shows the frequency of communications with the contact over the plurality of days.

13. The system of claim 12, wherein:
at least one day in the plurality of days shown in the calendar view comprises a first visual indicator with an intensity level corresponding to a number of message objects in the subset corresponding to communications associated with the contact on the at least one day, and
at least one day in the plurality of days shown in the calendar view comprises a second visual indicator representing the corresponding communication channels for each of the communications associated with the contact on the at least one day.

14. The system of claim 13, wherein the first visual indicator comprises a color, the intensity level comprises a predetermined shade of the color, and the second visual indicator comprises a ring shape around the at least one day in the plurality of days shown in the calendar view.

15. A non-transitory computer-readable device having instructions stored thereon that, when executed by at least one computing device, cause the at least one computing device to perform operations comprising:
receiving a plurality of communications via a plurality of communication channels;
extracting message objects from each communication in the plurality of communications, the message objects comprising a sender address, a recipient address, a message body, and a corresponding communication channel of the plurality of communication channels for each communication;
identifying a contact based on at least one of the message objects for each communication;
aggregating a subset of the message objects corresponding to communications associated with the contact among the plurality of communications to obtain aggregated message data; and
generating a visual representation of the aggregated message data for display, the visual representation comprising a temporal distribution of the subset of the message objects corresponding to the communications associated with the contact and the corresponding communication channels for each of the communications associated with the contact.

16. The non-transitory computer-readable device of claim 15, wherein generating the visual representation of the aggregated message data for display comprises generating a calendar view showing the communications associated with the contact and the corresponding communication channels for each of the communications associated with the contact over a predetermined period of time

17. The non-transitory computer-readable device of claim 16, the operations further comprising:
identifying, by the one or more computing devices, a frequency of communications with the contact based on the aggregated message data over the predetermined period of time.

18. The non-transitory computer-readable device of claim 17, wherein:
the predetermined period of time comprises a plurality of days, and
the calendar view further shows the frequency of communications with the contact over the plurality of days.

19. The non-transitory computer-readable device of claim 18, wherein:
at least one day in the plurality of days shown in the calendar view comprises a first visual indicator with an intensity level corresponding to a number of message objects in the subset corresponding to communications associated with the contact on the at least one day, and
at least one day in the plurality of days shown in the calendar view comprises a second visual indicator representing the corresponding communication channels for each of the communications associated with the contact on the at least one day

20. The non-transitory computer-readable device of claim 19, wherein the first visual indicator comprises a color, the intensity level comprises a predetermined shade of the color, and the second visual indicator comprises a ring shape around the at least one day in the plurality of days shown in the calendar view.
